(19) United States
(12) Patent Application Publication
(10) Pub. No.: US 2005/0085278 A1
(43) Pub. Date: Apr. 21, 2005

(54) DATA AND CHARGE ADAPTOR FOR MOBILE DEVICE

(76) Inventor: Chao-Hua Lin, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,651

(22) Filed: Oct. 15, 2003

(51) Int. Cl. H04B 1/16; H04M 1/00; H04B 1/38

(52) U.S. Cl. 455/573; 455/343.1

(57) ABSTRACT

A first port and cable having a first power line and a first data line connects to a host computer, a second port and cable having a second data line connects to a data port of a mobile device, and a third port and cable with a third power line connects to power port of the mobile device. The first data line and second data line are connected through a data converter installed in a housing for converting first format data on the first data line to second format data on the second data line. The first port can be integral with the housing, omitting the first cable. The second cable and third cable can be removable from the housing via connectors to facilitate customizability.

### BACKGROUND OF INVENTION

1. Field of the Invention

The present invention relates to an electronic device adaptor, and more specifically, to data and charge adaptor for connecting a mobile device to a host device.

2. Description of the Prior Art

Mobile devices such as cellular phones and personal digital assistants (PDAs) are becoming ever popular. All such mobile devices share two characteristics that enable portability: small size and battery power. Even though these two characteristics have advantages, they also create new problems. For example, while small device size allows these devices to be conveniently carried in a pocket or purse, this trait necessitates tiny and often cluttered user interfaces. And, while battery power is essential to independence from common power outlets, batteries must be charged or replaced regularly.

To address the problem of a cluttered user interface, a mobile device can be connected to a host device (e.g. desktop or notebook computer) via a communications cable. The communications cable typically connects data ports of the mobile device and the host device. The cable, when connected, is supported at both ends by driver software. Thus, the more convenient host device interface can be used to program the mobile device. Such a setup is commonly used to temporarily allow a user to use the interface of the host device or, equally important, to download large amounts of data to the mobile device.

To address the problem of battery run down, charging adaptors are commonly employed. A charging adaptor typically connects a power/charging port of the mobile device to an external power source (e.g. wall outlet or computer). Then, the rechargeable battery of the mobile device can be charged. Once, the battery is charged, the mobile device can be unplugged from the charging adaptor and used portably.

As the host device is usually a source of data and power, it is of interest to address these two problems together. Such a solution is taught in U.S. Pat. No. 6,531,845 to Kerai et al., which is incorporated herein by reference. Kerai et al. teach a universal serial bus (USB) cable for connecting a mobile telephone to a laptop computer. While such a cable may be convenient, it suffers three distinct disadvantages. First, a user may need a unique cable for each phone that they own as different phones commonly have different types of communications ports. Second, Kerai et al.s cable requires software activation at the computer to begin charging the mobile phone. That is, the user must initiate charging of the phone with a suitable command. And third, such a cable requires USB ports on both the host device and the mobile device, which limits the possible applications and introduces the requirement for software. Thus, an improved data charge adaptor for mobile devices is required.

### SUMMARY OF INVENTION

It is therefore a primary objective of the claimed invention to provide an adaptable data and charge adaptor for connecting a mobile device to a host device.

Briefly summarized, the claimed invention includes a first power line and a first data line for connecting to the host device, and a second data line and a third power line for connecting to the mobile device. The first data line and second data line are connected through a data converter, the data converter installed in a housing for converting first format data on the first data line to second format data on the second data line. The first power line and first data line are in one cable connected to the housing or are integrally formed in the housing. The second data line and third power line are separate cables and can be removable from the housing via connectors to facilitate customizability.

It is an advantage of the claimed invention that the data converter allows data at the host device and data at the mobile device to be of different formats.

It is further advantage of the claimed invention that separate and removable cables for the mobile device power and data lines make the charge adaptor fully customizable to a wide variety of mobile devices.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram of a data and charge adaptor according to the present invention connecting a mobile device to a host device.

FIG. 2 is a schematic diagram of the data and charge adaptor of FIG. 1 according to the first embodiment.

FIG. 3 is a schematic diagram of the data and charge adaptor of FIG. 1 according to the second embodiment.

FIG. 4 is a block diagram of the data and charge adaptor of FIG. 1.

### DETAILED DESCRIPTION

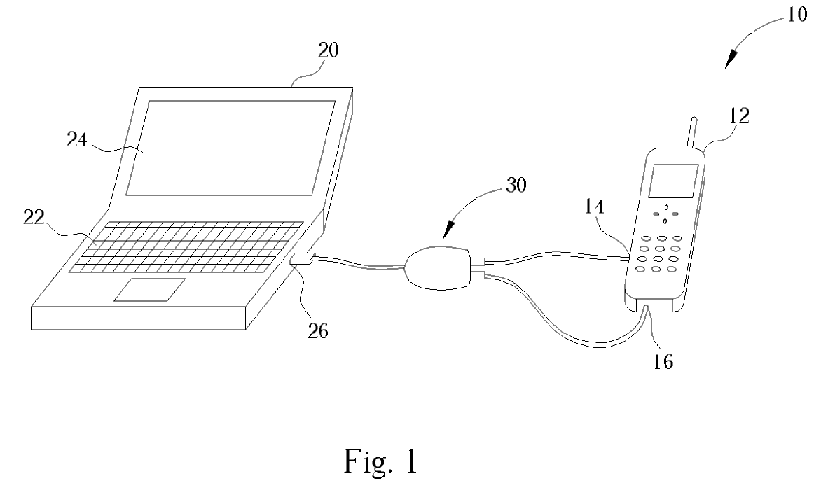

Please refer to FIG. 1 illustrating a perspective diagram of a charging system 10 according to the present invention. A mobile electronic device (i.e. mobile phone) 12 is connected to a host computer 20 by a data and charge adaptor 30. The host computer 20 includes a keyboard 22 and a display device 24 as a user interface for controlling operations of an internal processor (not shown). The computer 20 also includes a universal serial bus (USB) port 26 for connecting to external devices. The USB port 26 is typical, in that it can provide data communication and electrical power to an externally connected device. The mobile phone 12 includes a data port 14 for exchanging data with an external device and a power port 16 for receiving operating and battery charging power. The present invention data and charge adaptor 30 connects the data port 14 and charge port 16 of the mobile phone 12 to the USB port 26 of the host computer 20.

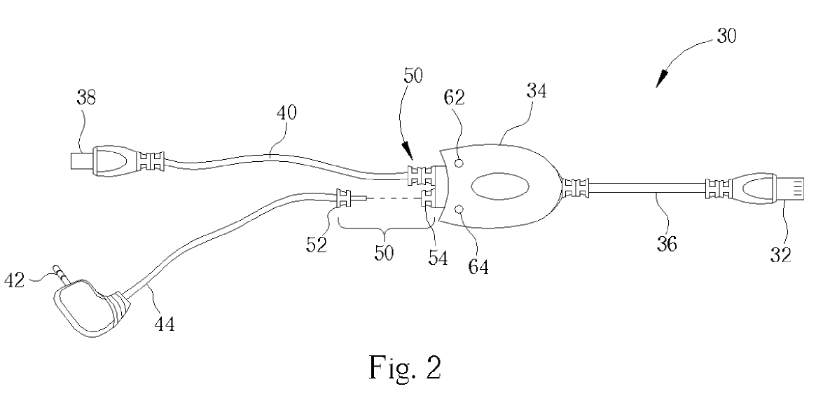

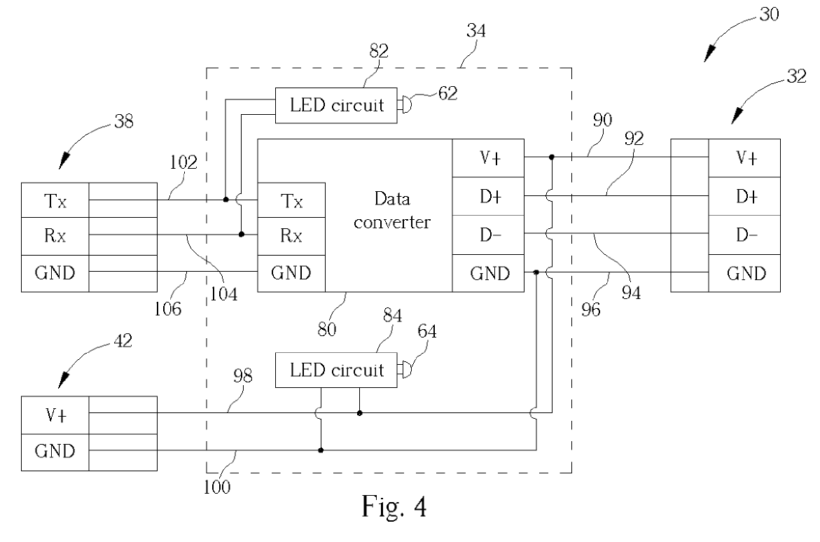

FIG. 2 illustrates the first embodiment of the data and charge adaptor 30. The data and charge adaptor 30 includes a first port 32 for connecting to the USB port 26 of the host computer 20 (FIG. 1), a housing 34 for holding a data converter (ref. 80 of FIG. 4), and a first cable 36 connecting the first port 32 and the housing 34. The data and charge adaptor 30 further includes a second port 38 connected to the housing 34 by a second cable 40, and a third port 42 connected to the housing 34 by a third cable 44. The second and third ports 38, 42 are for connecting respectively to the data port 14 and charge/power port 16 of the mobile phone 12 (FIG. 1). The first port 32, being a USB port, has data and power lines that run through the first cable 36, the data, power, and ground lines connecting to the data converter 80 in the housing 34 and the power and ground lines further connecting through to the third port 32. The second port 38 has data lines that run through the second cable 40 and electrically connect to the data converter 80 in the housing 34. Further illustrated in FIG. 2 are connectors 50 for mechanically and electrically connecting the second and third ports 38, 40 to the external housing 34 and to the internal data converter 80 respectively. The connectors 50 are of well-known design, and include a cable plug 52 (male) and a cable socket 54 (female). For illustrative purposes, in FIG. 2 the connector 50 of the second cable 40 is shown connected and the connector 50 of the third cable 44 is shown disconnected.

The connectors 50 allow the second and third ports 38, 42 and associated second and third cables 40, 44 to be removed and replaced. While USB is a serial port standard that is found on nearly all currently manufactured computers, mobile devices such as phones and PDAs do not follow a uniformly accepted standard for power and data ports. Thus, the connectors 50 allow a user to interchange various kinds of second and third ports 38, 42 to suit whichever models of phone(s) that they own. For example, the users two mobile phones may have different types of data ports and thus require two different versions of the second port 38 and cable 40, and yet may use the same type of power port necessitating only one version of the third port 42 and cable 44. The connectors 50 allow for a high degree of customizability while at the same time reusing the standardized components (i.e. USB port 32).

Further provided on the data and charge adaptor 30 are two light emitting diodes (LEDs) 62, 64 that respectively indicate if a data transfer or charging process is ongoing. Please note that the LEDs 62, 64 are for user convenience only and are not necessary to realize the primary functions of the data and charge adaptor 30.

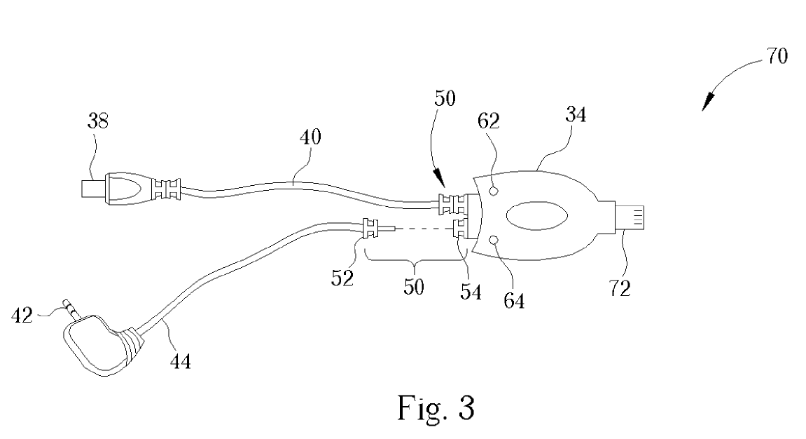

Please refer to FIG. 3. FIG. 3 illustrates the second embodiment of the present invention data and charge adaptor. Similar to the data and charge adaptor 30 according to the first embodiment, a data and charge adaptor 70 includes a housing 34, a second port 38 connected to the housing 34 by a second cable 40, and a third port 42 connected to the housing 34 by a third cable 44. The second and third ports 38, 40 and the second and third cables 40, 44 are again removably connected via connectors 50 having plugs 52 and sockets 54. The key difference between the data and charge adaptors 70 and 30 is that the data and charge adaptor 70 has a first port 72 integrally mounted in the housing 34. That is, the second embodiment does not require the first cable 36. Other than this difference, the data and charge adapter 70 is identical to the data and charge adaptor 30, and includes all the previously described data, power, and ground lines, etc.

Please refer to FIG. 4 illustrating a block diagram of the internal electronics of the first embodiment data and charge adaptor 30 of FIG. 2. Although, the electronics of the data and charge adaptor 30 are described in the following, this description also applies to the data and charge adaptor 70 as the key difference is mechanical. FIG. 4 illustrates the housing 34, the first, the second, and the third ports 32, 38, 42 previously described, as well as the lines connected to these ports. Also shown in FIG. 4 are the data converter 80 for converting the first format (USB) data at the first port 32 to the second format data (mobile device data) at the second port 38, and two LED circuits 82, 84 for controlling the LEDs 62, 64 respectively.

Shown in FIG. 4 are a power line 90 (V+), data lines 92, 94, and a ground line 96 (GND) that connect the first port 32 to the data converter 80. The USB data lines 92, 94 are marked D+ and D− as conventional in the USB standard. A power line 98 and ground line 100 connect the third port 42 to the corresponding lines 90, 96 of the first port 32. Data lines 102, 104 and ground line 106 are connected between the second port 38 and the data converter 80. The data lines 102 and 104 are marked Tx and Rx at the second port 38 and are for transmitting and receiving data respectively. Such a data line structure is conducive to the second port 38 being an RS-232 port for example.

The data converter 80 is at least capable of converting data from a first format (USB) at the first port 32 to a second format (RS-232) at the second port 38. Two-way conversion is also possible and desirable if uploading from the mobile device 12 to the host computer 20 is required. The data converter is a well-known IC device such as Prolifics PL-2303X or Future Technology Devices Intl.s FT 232AM.

The LED circuit 82 enables the LED 62 to indicate active data transfer to/from the mobile device 12 across the data lines 102, 104. Similarly, the LED circuit 84 enables the LED 64 to indicate active battery charging of the mobile device 12 by a potential between the power line 98 and ground line 100. The exact specifications of the LED circuits 82, 84 are left to a skilled designer.

Prior to operation, the user must select the specific second and third ports 38, 42 for the specific brand of mobile phone to be used. Then, the user connects the second and third ports 38, 42 to the housing 34 by way of the connectors 50. Optionally, the user may wish not to connect both ports 38, 42 if only one function (charge or data transfer) is to be used. The user then plugs the second port 38 into the data port 14 and the third port 42 into the power port 16 of the mobile phone 12 as required. Finally, the user connects the first port 32, 72 to the port 26 of the host computer 20. Charging of the mobile devices battery then commences automatically as the USB power line 90 is pulled high by the port 26 of the host computer 20. At this time, the user can execute a software application on the host computer 20 to facilitate data transfer to/from the mobile device 12. In this way, the present invention data and charge adaptors 30, 70 can be used to provide both data and power to the mobile device 12.

In contrast to the prior art, the present invention includes a data converter for converting data between a host format and a mobile device format. The present invention data and charge adaptor further includes separate ports and cables for different types of mobile devices. The ports and cables are removably connected to a housing via connectors and allow for multiple types of mobile device ports.

Those skilled in the art will readily observe that numerous modifications and alterations of the device may be made while retaining the teachings of the invention. Accordingly, the above disclosure should be construed as limited only by the metes and bounds of the appended claims.

1. A data and charge adaptor for connecting a mobile device to a host device, the data and charge adaptor comprising:
a first port comprising a first power line and at least a first data line, the first port for connecting to a communication port of the host device;
a data converter comprising at least a first end electrically coupled to the first data line, the data converter for converting first format data at the first end to second format data at at least a second end;
a second port comprising at least a second data line electrically connected to the second end, the second port for connecting to a corresponding data port of a mobile device;
a third port comprising a third power line electrically coupled to the first power line, the third port for connecting to a corresponding power port of the mobile device; and
a housing for holding the data converter.

2. The data and charge adaptor of claim 1 wherein the first port is a universal serial bus (USB) port comprising two first data lines electrically connected to two first ends of the data converter, and comprising a first ground line electrically connected to a third ground line of the third port.

3. The data and charge adaptor of claim 1 wherein the second port further comprises three second data lines being a transmit line, a receive line, and a ground line electrically connected to three second ends of the data converter.

4. The data to charge adaptor of claim 1 further comprising a first ground line of the first port electrically connected to a third ground line of the third port.

5. The data and charge adaptor of claim 1 further comprising a second cable and a third cable connected to the housing for separately housing the second data line and the third power line.

6. The data and charge adaptor of claim 5 wherein the second port, second data line, and second cable are mechanically and electrically removably connected to the housing by a second cable connector.

7. The data and charge adaptor of claim 5 wherein the third port, third power line, and third cable are mechanically and electrically removably connected to the housing by a third cable connector.

8. The data and charge adaptor of claim 1 further comprising a first cable for housing the first data and power lines.

9. The data and charge adaptor of claim 1 wherein the first port is integrally connected to the housing.

10. The data and charge adaptor of claim 1 wherein the data converter is capable of converting data of the second format at the second end to data of the first format at the first end.

11. The data and charge adaptor of claim 1 further comprising a charge light emitting diode (LED) electrically coupled to the first or third power line, the charge LED for indicating power on the first and third power lines.

12. The data and charge adaptor of claim 1 further comprising a data LED electrically connected to the first or second data line, the data LED for indicating data transfer between the first and second data lines.

13. A data and charge adaptor for connecting a host device communication port to a mobile device data port and a mobile device power port, the host device communication port comprising a host data port and a host power port, the data and charge adaptor comprising:
a first cable comprising a first power line and a first data line, the first data line for electrically coupling to the host data port for receiving a first format data, the first power line for electrically coupling to the host power port for receiving power;
a housing comprising a second cable socket and a third cable socket, the third cable socket electrically coupled to the first power line;
a data converter disposed within the housing, the data converter electrically coupled to the first data line for converting the first format data to a second format data, and outputting the second format data to the second cable socket;
a second cable having a plug removably attached to the second cable socket, the second cable comprising a second data line for electrically coupling to the mobile device data port and forwarding the second format data to the mobile device data port; and
a third cable having a plug removably attached to the third cable socket, the third cable comprising a third power line for electrically coupling to the mobile device power port and forwarding power to the mobile device power port.

14. The data and charge adaptor of claim 13 wherein the host data and power ports are a universal serial bus (USB) port comprising two first data lines electrically coupled to the data converter, and further comprising a first ground line electrically connected to a third ground line of the third cable.

15. The data and charge adaptor of claim 13 wherein the second cable comprises three second data lines being a transmit line, a receive line, and a ground line electrically connected to the data converter.

16. The data to charge adaptor of claim 13 further comprising a first ground line of the first cable electrically connected to a third ground line of the third cable.

17. The data and charge adaptor of claim 13 wherein the data converter is capable of converting second format data at the second cable socket to first format data at the first data line.

18. The data and charge adaptor of claim 13 further comprising a charge light emitting diode (LED) electrically connected to the first or third power line, the charge LED for indicating power on the first and third power lines.

19. The data and charge adaptor of claim 13 further comprising a data LED electrically connected to the first or second data line, the data LED for indicating data transfer between the first and second data lines.
